(19) United States
(12) Patent Application Publication
(10) Pub. No.: US 2026/0073747 A1
(43) Pub. Date: Mar. 12, 2026

(54) KEYLESS DIGITAL LOCKING SYSTEM AND METHOD FOR SECURING MULTIPLE ACCESS POINTS OF AN ASSET

(71) Applicant: KritiLabs Technologies Private Limited, Chennai (IN)

(72) Inventors: Marur Venkataraman Varadharajan, Chennai (IN); Gunasekar Rathinam, Chennai (IN); Marur Varadharajan Srikrishna, Chennai (IN); Lalgudi Natarajan Rajaram, Chennai (IN)

(21) Appl. No.: 19/277,172

(22) Filed: Jul. 22, 2025

(30) Foreign Application Priority Data
Sep. 6, 2024 (IN) 202441067687

(51) Int. Cl. G07C 9/00; G07C 9/27

(52) U.S. Cl. CPC G07C 9/00944; G07C 9/00571; G07C 9/00896; G07C 9/27; G07C 2009/0092

(57) ABSTRACT

The present invention discloses an advanced locking solution with a modular design and the capability to secure multiple points of asset openings at a single junction. The locking system comprises of a L-plate (102) provided with 2 parallel plates (110), a Flat plate with a hole (104), a Lock (106). The L-Plate (102) is securely fabricated onto the designated area of the asset/truck, by welding it to the chassis or frame of the truck. Once the L-plate (102) is in place, the flat plate with a hole (104) goes through the L-plate (102) in between the two parallel plates (112). Next, the Lock (106) is fixed onto the L-plate (102). Finally, the flat plate (104) is welded to the specific component in the truck such as the rod or lever, whose movement needs to be restricted.

The following specification particularly describes the invention and the manner in which it is to be performed.

### FIELD OF INVENTION

The present invention relates to a system and method of securing the storage and transportation of high-value assets by employing a locking mechanism. More particularly, it relates to a modular and larger locking system and method that enables locking of multiple points of the asset openings at a single point.

### BACKGROUND OF THE INVENTION

When transporting high-value assets in trucks, it is crucial to prioritize the security of the locking mechanisms on the doors. Implementing robust locks specifically designed for cargo doors is essential. By choosing the right type of locks, be it heavy-duty padlocks, plunger locks, electronic locks, seal locks, or crossbar locks-companies can protect their assets from theft. Cargo locks, also known as container locks, are specifically designed to secure the cargo area of trucks, trailers, containers, and other vehicles used for transporting goods. These locks play a crucial role in ensuring the safety and security of valuable assets during transit.

In recent days, the types of cargo locks commonly used in transportation and logistics have evolved to incorporate more advanced features and technologies aimed at enhanced security and operational efficiency. The most commonly used types of cargo locks are Electronic and Smart Locks, Tamper-Evident Seals, and Heavy-Duty Padlocks. There is also an increasing demand for customized locking solutions that meet specific security needs and cargo requirements, including compatibility with various types of vehicles and containers. Despite advancements, some traditional locks may still be vulnerable to sophisticated methods of forced entry such as lock picking, drilling, or bypassing.

Cargo containers and trucks often have multiple access points or openings where assets are loaded, stored, and accessed. These openings can vary depending on the type of container or vehicle, the cargo being transported, and operational requirements. Having multiple asset openings in cargo containers or trucks presents both opportunities and challenges. However, the drawback lies in the complexity of securing these multiple access points effectively. Each opening represents potential vulnerability if not properly secured, leading to increased risks of theft or unauthorized access.

To overcome such limitations, the present invention aims to introduce an advanced modular locking system and a method for securing the storage and transportation of high-value assets in trucks. The present invention offers a locking solution that allows multiple points of asset openings to be secured with a single lock mechanism. It features a singular locking module or plunger that can secure multiple access points at a junction. The present invention also facilitates modularization, allowing for faster installation and servicing of lock components. The locking system can be fixed to the asset and accommodates various types of locks for securing the asset.

### VARIOUS PRIOR ARTS HAVE DISCLOSED SIMILAR SYSTEMS AND METHODS

US Patent Application US20150052817A1 discloses a locking system for a casement window featuring a side plunger that moves horizontally to engage a keeper and connects to a flexible transfer band. This band wraps around a corner block and links to a top plunger that moves vertically to secure the window. The prior art uses separate side and top plungers that move along respective axes to engage keepers through horizontal and vertical movements. In the present invention, however, a single plunger is used to lock multiple points at one junction. The present invention features a locking mechanism wherein the flat plate and L-plates are aligned with holes, and the plunger extends through holes, thereby locking the flat plate against the L-plate. Unlike the prior art, which is designed for casement windows, the present invention offers a locking solution specifically for securing high-value assets in trucks or cargo.

WIPO Patent Application WO2017174732A1 discloses a modular lock system consisting of a lock body and a lock insert that can be adjusted for sliding or swinging doors. The prior arts use a locking pin inside the lock insert to either block or allow a locking member to move and it is controlled by a locking element that switches between restricting and non-restricting states. It is important to highlight that the present invention provides a locking solution that allows multiple points of asset openings to be secured with a single lock mechanism. Unlike prior art, the singular locking module or plunger is used to secure multiple access points at a junction.

Considering the aforementioned prior arts, the present invention distinguishes itself by providing a larger locking solution ensuring that multiple points of asset openings can be locked at a single point. This invention ensures that the locking module or plunger can be singular while connecting multiple points of locking at this junction point. It enables modularization of the locking system enabling faster installation and service components of the lock itself. The solution can be fixed to the asset and ensures different kinds of locks can be used to secure the asset.

### OBJECTS OF THE INVENTION

The main object of the present invention is an advanced keyless digital locking system and a method for securing the storage and transportation of high-value assets in trucks in an automated manner and from a remote place based on intelligent application of rules such as time of day, geo location of the truck, authentication of person empowered to operate the lock, etc

It is another object of the present invention to offer a comprehensive locking solution that allows multiple points of asset openings, such as domes and hatches on top or valves and manifold boxes on the bottom, to be secured with a single lock mechanism.

It is another object of the present invention to provide a locking solution where the single locking module with a plunger can secure multiple access points at a junction.

It is another object of the present invention to develop a locking system that facilitates modularization, allowing for faster installation and servicing of lock components.

It is another object of the present invention to provide a locking system that can be fixed to the asset and accommodates various types of locks for securing the asset.

### SUMMARY OF THE INVENTION

The present invention introduces an advanced locking solution with a keyless modular design and the capability to secure multiple points of asset openings at a single junction. The present invention ensures that the locking module/plunger can be singular while connecting multiple points of locking at this junction point. This enables modularization of the locking system enabling faster installation and service components of the lock itself. The present invention supports easy customization and scalability, catering to diverse requirements. By integrating locks directly into the L-plate component, the system ensures compatibility with various lock types, thereby enhancing versatility.

The system disclosed by the present invention comprises the following components: an L-Plate, a Flat plate with a hole, a Lock with a plunger, and a Protective hole cover. L-Plate is an L-shaped structure in which the lock is placed. At one end of the structure, there are two parallel plates with matching holes. Between the parallel plates, there is a gap through which a flat plate can move vertically. The plunger of the lock will move horizontally through these two holes. The flat plate moves vertically through the parallel plates in the L-Plate structure. The length of the flat plate will vary depending on the asset. It is an electronically driven lock that is fixed on the L-Plate so that the plunger moves through the matching holes of the L-Plate and the Flat plate thereby immobilizing the flat plate which in turns secures all the other access points. The protective hole cover is a transparent cover that is placed to protect the plunger when it juts out of the outer end of the hole in the L-Plate structure, when in ‘Locked’ state. The protective hole cover protects the plunger from wilful damage through the outer end of the hole in the L-Plate structure.

### BRIEF DESCRIPTION OF THE DRAWINGS

FIG. 1 illustrates the complete structure of the locking assembly showing both the Right-Side View (A) and Left-Side View (B) in accordance with the present invention.

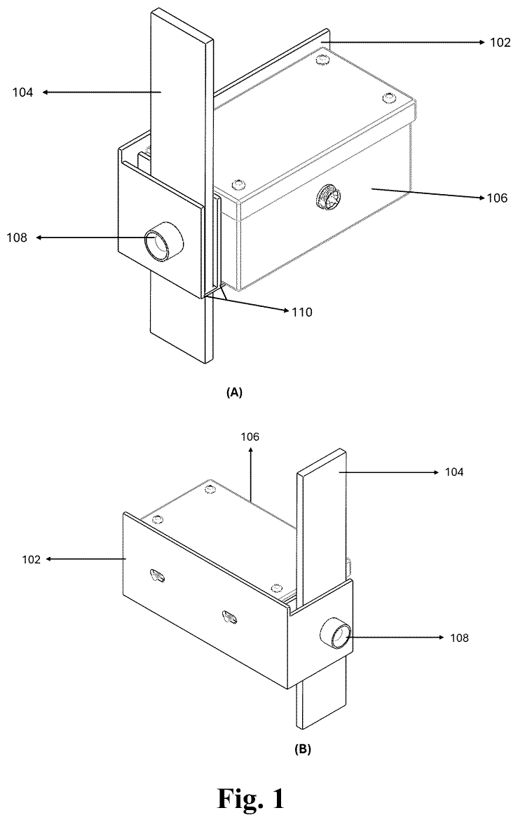

FIG. 2 illustrates the structure of the L-Plate in accordance with the present invention.

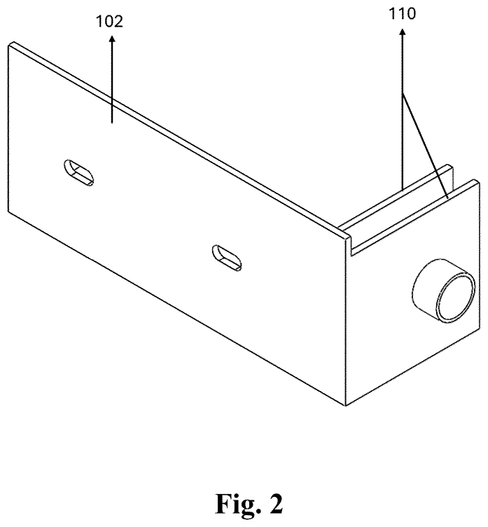

FIG. 3 illustrates the structure of the flat plate with a hole in accordance with the present invention.

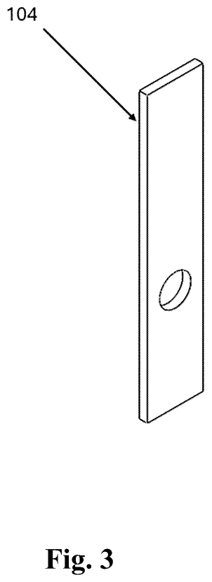

FIG. 4 illustrates the structure of the lock cabinet in accordance with the present invention.

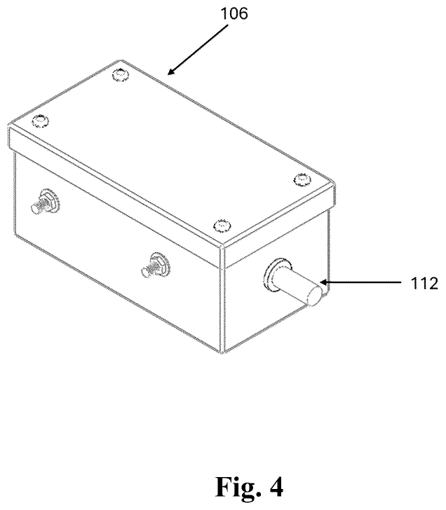

FIG. 5 illustrates the diagram of the protective hole cover in accordance with the present invention.

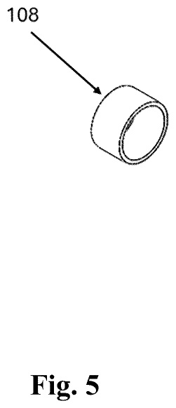

FIG. 6 illustrates the lock installed on a truck in accordance with the present invention.

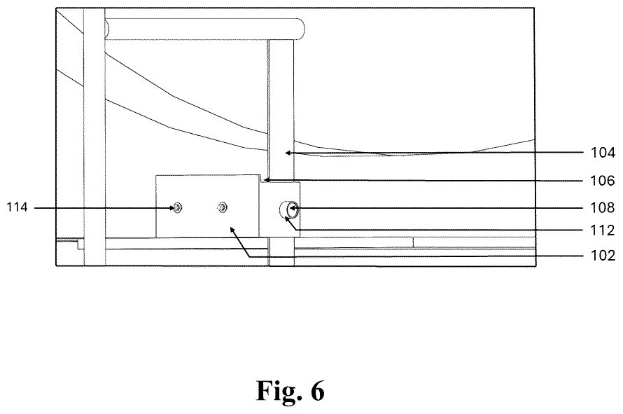

FIG. 7 illustrates the lock installed on a truck, with the cable connected to the IoT platform in a cabin of the truck in accordance with the present invention.

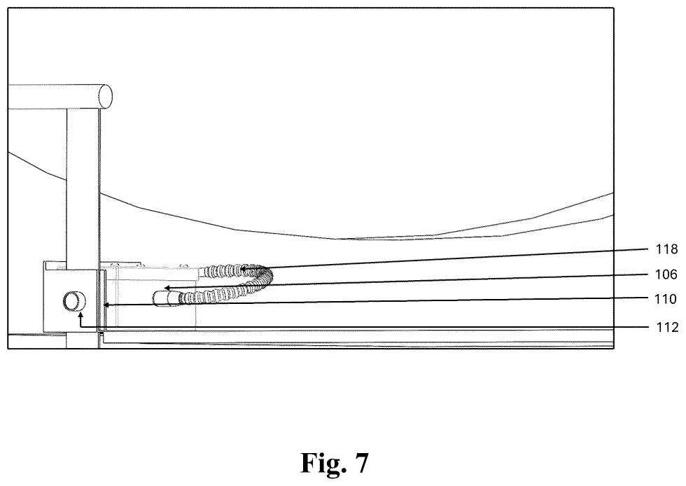

FIG. 8 illustrates the drawing of an electronic controller device (controller) in accordance with the present invention.

Provided below is the list of components of the present invention along with its reference numerals:

| | REFERENCE |
|---|---|
| PART DESCRIPTION | NUMERAL |
| L-Plate | 102 |
| Flat plate with hole | 104 |
| Lock | 106 |
| Protective Hole Cover | 108 |
| Parallel Plates | 110 |
| Plunger | 112 |
| Elliptical holes and Lock Nuts for | 114 |
| securing Lock on L-Plate | |
| Controller (electronic device) | 116 |
| Cable connecting to IOT platform | 118 |
| in cabin | |

While the invention is amenable to various modifications and alternative forms, specifics thereof have been shown by way of examples in the drawings and will be described in detail. It should be understood, however, that the intention is not to limit the invention to the particular embodiments described. On the contrary, the intention is to cover all modifications, equivalents, and alternatives falling within the spirit and scope of the invention.

Hereinafter, preferred embodiments of the present invention will be described in detail with reference to the accompanying drawings. Prior to this, terms and words used in the present specification and claims should not be construed as limited to ordinary or dictionary terms, and the inventor should appropriately interpret the concept of the term appropriately to describe its own invention in the best way. The present invention should be construed as meaning and concept consistent with the technical idea of the present invention based on the principle that it can be defined. Therefore, the embodiments described in this specification and the configurations shown in the drawings are only the most preferred embodiments of the present invention and do not represent all the technical ideas of the present invention. Therefore, it should be understood that equivalents and modifications are possible.

### DETAILED DESCRIPTION OF THE INVENTION WITH RESPECT TO THE DRAWINGS

The present invention as embodied by “A Keyless Digital Locking System and method for securing multiple access points of an asset” succinctly fulfils the above-mentioned need(s) in the art. The present invention has objective(s) arising as a result of the above-mentioned need(s), said objective(s) being enumerated below. In as much as the objective(s) of the present invention are enumerated, it will be obvious to a person skilled in the art that, the enumerated objective(s) are not exhaustive of the present invention in its entirety and are enclosed solely for the purpose of illustration. Further, the present invention encloses within its scope and purview, any structural alternative(s) and/or any functional equivalent(s) even though, such structural alternative(s) and/or any functional equivalent(s) are not mentioned explicitly herein or elsewhere, in the present disclosure. The present invention therefore encompasses also, any improvisation(s)/modification(s) applied to the structural alternative(s)/functional alternative(s) within its scope and purview. The present invention may be embodied in other specific form(s) without departing from the spirit or essential attributes thereof.

Throughout this specification, the use of the word “comprise” and variations such as “comprises” and “comprising” may imply the inclusion of an element or elements not specifically recited.

The present invention discloses an advanced keyless digital locking solution designed to secure multiple access points with a single locking mechanism. The present invention allows for a single locking module or plunger to connect and secure multiple points on the asset simultaneously. This modular approach streamlines the locking system, facilitating faster installation and maintenance of the lock components. Additionally, the system can be securely affixed to the asset and accommodates various types of locks to ensure comprehensive safety measures.

In the preferred embodiment of the present invention, wherein the locking system comprises the following components: a L-plate (102), a Flat plate with a hole (104), a Lock (106), and a Protective hole cover (108).

In the preferred embodiment, wherein one end of the L-plate (102) is provided with two parallel plates (110) that have matching holes. A gap is provided between the two parallel plates (110), through which a flat plate (104) is positioned vertically. The plunger (112) of the lock will move horizontally through the two holes of the parallel plates (110) and the hole of the flat plate (104) positioned between the parallel plates (110).

In the preferred embodiment, wherein the flat plate (104) moves vertically through the parallel plates (110) in the L-Plate structure (102). The length of the flat plate will vary depending on the asset.

In the preferred embodiment, wherein an electronic lock (106) is fixed on the L-Plate (102) so that the plunger (112) moves through the matching holes of the L-Plate (102) and the Flat plate (104).

In the preferred embodiment, wherein the protective hole cover (108) is provided which is a transparent cover used to protect the plunger when it juts out of the outer end of the hole in the L-Plate structure (102), when in ‘Locked’ state. The protective hole cover protects the plunger from wilful damage through the outer end of the hole in the L-Plate structure.

In the preferred embodiment of the present invention, wherein the lock installed on a truck is connected to an electronic controller device which could also be a mobile smart phone allowing the user to operate the lock. The electronic controller device or the Mobile smart phone is connected to a remote server on the cloud through the internet.

The controller device (116) is instructed by the application running on the server and upon receiving authorization from the server, the controller device (116) triggers the locking or unlock operations of the lock (106).

In the preferred embodiment of the present invention, wherein the server in the cloud stores information of the remote asset and predefined rules to perform necessary operations related to management of plurality of remote assets.

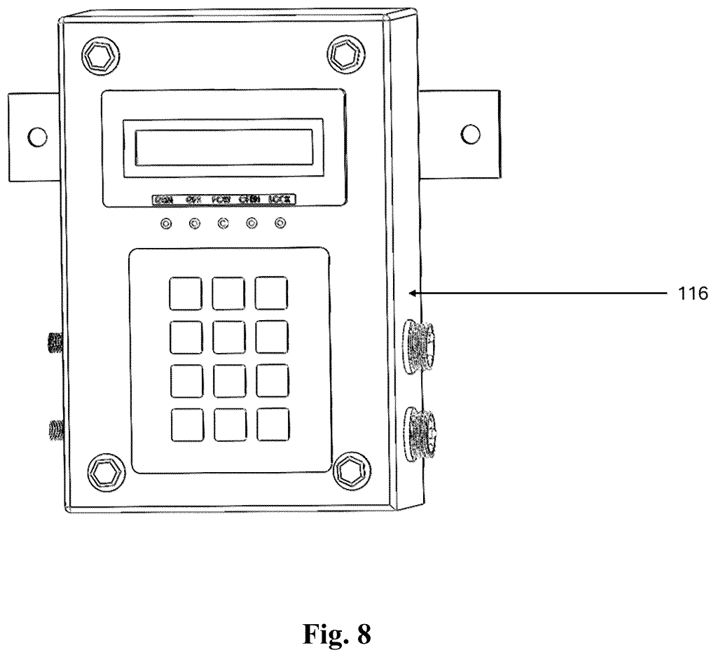

In the preferred embodiment of the present invention, wherein the electronic controller device (116) could be a controller device with a keypad and display, as shown in FIG. 8, to operate the lock through wireless or Bluetooth or wired connectivity with the lock.

In another embodiment of the present invention, wherein the electronic controller device can be any smartphone with an app or Bluetooth to operate the lock.

### Assembly of the Locking System:

The assembly of the present system involves several key steps to ensure proper functionality and stability. First, the L-Plate (102) is securely fabricated onto the designated area of the asset/truck, typically by welding it to the chassis or frame of the truck, thereby making the locking system as an integral part of the truck carrying the cargo. Once the L-plate (102) is in place, the flat plate with a hole (104) goes through the L-plate (102) in between the two parallel plates (112). Next, the Lock (106) is fixed onto the L-plate (102). Finally, the flat plate (104) is welded to the specific component in the truck such as the rod or lever, whose movement needs to be restricted. This ensures the components remain firmly in place.

### Method of Operating the Locking System:

In the preferred embodiment of the present invention, wherein the method of operating the locking system involves several steps. First, the flat plate (104) is positioned relative to the L-plate (102) so that the respective holes are perfectly aligned. Once the holes are aligned, the lock's plunger (112) is extended and moves through the aligned holes of the flat plate (104) and L-plate (102). In this position, the flat plate (104) is held firmly against the L-plate (102), with the plunger (112) in place. This mechanism effectively prevents any movement of the flat plate (104) and the extended component attached to it, thereby engaging the lock mechanism. When the lock (106) is engaged (i.e.) the plunger (112) is inserted through aligned holes in the flat plate (104) and L-plate (102), and it firmly holds the flat plate (104) in place. This setup ensures that the component welded to the flat plate (104) cannot move freely, providing safety during the storage and transportation of high-valued assets in the trucks.

### EXAMPLE

The present invention provides the L-Plate (102) which is securely fabricated onto the designated area of the truck, typically by welding it to the chassis or frame of the truck. Once the L-plate (102) is in place, the flat plate with a hole (104) goes through the L-plate (102) in between the two parallel plates (112). Next, the Lock (106) is fixed onto the L-plate (102). Finally, the flat plate (104) is welded to the specific component in the truck such as the rod or lever, whose movement needs to be restricted. This ensures the components remain firmly in place. The method of operating the locking system, comprises the steps of:
a. The controlling device connected through internet to the remote server is used to operate the lock through any wired or wireless means.
b. The first step involves positioning the L-plate (102) between the parallel plates (112) of the flat plate (104) wherein the L-plate (102) and the flat plate (104) are perpendicular to each other so that the respective holes are perfectly aligned.
c. Once the holes are aligned, the lock's plunger (112) is extended and moves through the aligned holes of the flat plate (104) and L-plate (102).
d. In this position, the flat plate (104) is held firmly against the L-plate (102), with the plunger (112) in place. This mechanism effectively prevents any movement of the flat plate (104) with the extended component attached to it, thereby engaging the lock mechanism.
e. When the lock (106) is engaged (i.e.) the plunger (112) is inserted through aligned holes in the flat plate (104) and L-plate (102), it firmly holds the flat plate (104) in place;

Thus, the method provides an advanced locking solution with the capability to secure multiple points of asset openings at a single junction. It ensures that the locking module/plunger can be singular while connecting multiple points of locking at this junction point.

The keyless digital lock can be operated/triggered entirely automatically as per a set of rules/instructions configured in the server. Alternatively, the keyless digital lock (106) can be triggered manually by an authorized person entering a code in the controlling device (116). The commands to operate is received directly from the server on the cloud following a set of pre-defined rules or those commands can be triggered by a manual request by the user to operate the lock which will trigger the sequence of operations controlled by the server on cloud, wherein the generated code/command will be communicated to the user by the server through a message on the user's mobile device, which is then entered in the controller device (116) to operate the lock (106).

### Advantages of the Present Invention

1. Modular Design: The present invention provides a modularized keyless locking solution, offering flexibility and adaptability. It allows for easy customization and scaling of the system according to the specific needs or future requirements.

2. Multi-point Securement: The present invention provides a locking mechanism in which the vertical hole in the L-plate allows for connecting multiple delivery points, allowing them to be securely locked. It improves overall security by locking multiple points at once.

3. Versatile Lock Compatibility: The present invention provides a locking system in which the locks are directly fitted into the L-plate component. This ensures compatibility with various types of locks.

4. Quick Installation: The present invention provides a locking solution that is designed for rapid installation and deployment of locks.

5. Independent Lock Servicing: Maintenance or servicing of locks can be performed without affecting the welding or initial installation of the locking system.

6. The lock is tamper-evident as any attempt at tampering will render the lock unreusable and make the damage evident.

7. The L-Plate and lock design is unique where field installations and removals are made easy by the shape of the holes and the covering washers for ease of fitting and removal of the lock bolts into the L-plate holes, particularly as the back of the truck or any other asset may have limited space for maneuverability to place the lock in the exact place on the L-plate to match the lock bolts and L plate holes.

8. The lock works without a battery and draws power from the electronic device that gives it the command and only then. The lock thus stays locked or open and battery or power failure will not compromise the lock as in other access control systems. Nor can it be compromised by simply connecting it to another power source. This is also needed in hazardous environments where a battery pack in a product is not allowed.

Although the proposed concept has been described as a way of example with reference to various models, it is not limited to the disclosed embodiment and that alternative designs could be constructed without deviating from the scope of invention as defined above.

It will be apparent to a person skilled in the art that the above description is for illustrative purposes only and should not be considered as limiting. Various modifications, additions, alterations, and improvements without deviating from the scope of the invention may be made by a person skilled in the art.

We claim:

1. A Keyless Digital Locking System for securing multiple access points of an asset transporting or storing cargo, characterized in that:
a. a L-plate (102) provided with two parallel plates (110) on one end that have matching holes;
b. a flat plate (104) provided with a hole, wherein the flat plate (104) is positioned vertically between the parallel plates (110);
c. a lock (106) provided with a plunger (112) which is fitted onto the L-plate (102);
d. an electronic controller device (controller) (116) provided with a keypad and display that is connected through the internet to a remote server on the cloud, wherein the lock (106) installed on a truck is connected to the electronic controller device (116),
wherein the plunger (112) of the lock (106) is inserted horizontally into the two holes of the parallel plates (110) and the hole of the flat plate (104) positioned between the parallel plates (110).

2. The keyless digital locking system as claimed in claim 1, wherein a protective hole cover (108) is provided which is a transparent cover used to protect the plunger (112) when it juts out of the outer end of the hole in the L-Plate structure (102), when in ‘Locked’ state.

3. The keyless digital locking system as claimed in claim 1, wherein the L-Plate (102) is securely fabricated onto the designated area of the asset/truck, by welding it to the chassis or frame of the truck, thereby making the locking system as an integral part of the truck carrying the cargo.

4. The method of operating the keyless digital locking system as claimed in claim 1, wherein the method comprising of:
i. the flat plate (104) is positioned perpendicular to the L-plate (102) and within the parallel plates (110) so that the respective holes are aligned;
ii. the lock's plunger (112) is extended and moves through the aligned holes of the flat plate (104) and L-plate (102);
iii. the lock (106) is engaged when the plunger (112) is inserted through aligned holes in the flat plate (104) and L-plate (102) wherein the plunger (112) firmly holds the flat plate (104) in place,
wherein the flat plate (104) is welded to the specific component in the truck such as the rod or lever whose movement needs to be restricted.

5. The method of operating the locking system as claimed in claim 4, wherein the controlling device (116) is used to operate the lock through any wireless or wired connectivity.

6. The method of operating the locking system as claimed in claim 4, wherein the device (116) upon receiving authorization from the server, triggers the locking or unlocking operations of the lock.

7. The method of operating the locking system as claimed in claim 4, wherein the keyless digital lock (106) is operated automatically from a remote distance as per the instructions configured in the server.

8. The method of operating the locking system as claimed in claim 4, wherein the keyless digital lock (106) is triggered manually by an authorized person by entering a code in the controlling device (116), wherein the commands to operate the lock is received directly from the server on the cloud.

9. The method of operating the locking system as claimed in claim 8, wherein the keyless digital lock (106) is triggered manually by a request made by the authorized user to the server, which will trigger the sequence of operations controlled by the server on cloud, wherein the generated code/command is communicated to the user by the server through a message on the user's mobile device, which is then entered in the controller device (116).
